(19) United States
(12) Patent Application Publication
(10) Pub. No.: US 2015/0269378 A1
(43) Pub. Date: Sep. 24, 2015

(54) Use of a Physical Unclonable Function for Checking Authentication

(71) Applicant: SIEMENS AKTIENGESELLSCHAFT, München (DE)

(72) Inventor: Rainer Falk, Poing (DE)

(21) Appl. No.: 14/435,584

(22) PCT Filed: Aug. 13, 2013
(86) PCT No.: PCT/EP2013/066875

§ 371 Date: Apr. 14, 2015

(30) Foreign Application Priority Data
Oct. 19, 2012 (DE) 10 2012 219 112.7

(51) Int. Cl. G06F 21/45; H04L 29/06

(52) U.S. Cl. CPC G06F 21/45; H04L 63/083; H04L 63/105; G06F 2221/2121

(57) ABSTRACT

In order to check authentication using a physical unclonable function, an authenticator includes a physical unclonable function (PUF) and an authentication checking function. A challenge response pair provides challenge information and a response for the authenticator. The challenge information is used as an input for the PUF, which generates a PUF response in response to the input of the challenge information. The PUF response and the response are used for a comparison, wherein an enable signal is provided on the basis of a result of the comparison.

### CROSS-REFERENCE TO RELATED APPLICATIONS

The present patent document is a §371 nationalization of PCT Application Serial Number PCT/EP2013/066875, filed Aug. 13, 2013, designating the United States, which is hereby incorporated by reference, and this patent document also claims the benefit of DE 10 2012 219 112.7, filed on Oct. 19, 2012, which is also hereby incorporated by reference.

### TECHNICAL FIELD

This embodiments relate to the technical field of checking authentication using a Physical Unclonable Function (PUF).

### BACKGROUND

Authentication is a fundamental security mechanism. A user or an object may be authenticated. On the basis thereof, a functionality, for example of an IC, a control device, software or a service that may be reached via a network, may be activated or deactivated or restricted. For example, access to particular memory areas or to a configuration and diagnostic function (e.g. JTAG) or activation of a particular functionality (for example, charging batteries using currents above a threshold value) may be activated, deactivated, or restricted.

Authentication may be carried out using a password or a cryptographic key or using biometric properties of a user (e.g., fingerprint, etc.) or of a physical object (e.g., physical unclonable function). In this case, the authenticated person or object proves to have knowledge of a password or of a cryptographic key, or to have a particular property. Authentication through the possession of an article, for example, through the possession of a door key or an ID, is generally also known.

Device authentication of a semiconductor IC, (for example, a programmable logic module such as an FPGA), only functions or functions only in an unrestricted manner when a particular hardware module (e.g., security IC) is detected as being present. This prevents simple copying of FPGA bit files since a copied bit file may not be executed in another hardware environment in which there is no security IC or another security IC is present. One example is http://www.maxim-ic.com/app-notes/index.mvp/id/3826. Semiconductor ICs and control devices, for example, have diagnostic interfaces in order to be able to access internal functions during development, production, or repair. Access to such a functionality is protected during regular operation if sensitive information may be accessed using the functionality (for example, reading of stored keys). It is known practice to deactivate such interfaces when they are no longer required (e.g., by blowing a so-called security fuse). It is also known practice to protect access to a diagnostic interface using cryptographic methods (see, for example, Honeywell: ENCRYPTED JTAG INTERFACE, WO2007005706 and http://catt.poly.edu/content/researchreview10/SecurityExtensionstoJTAG.pdf).

Physical unclonable functions (PUF): an overview of physical unclonable functions (PUF) is provided by the lecture notes http://www.sec.in.tum.de/assets/lehre/ss10/sms/sms-kap6-rfid-teil2.pdf.

Physical unclonable functions are known in order to reliably identify objects using their intrinsic physical properties. In this case, a physical property of an article (for example, a semiconductor IC) is used as an individual “fingerprint”. The authentication of an object is based on an associated response value being returned by a PUF function defined by physical properties on the basis of a challenge value. Physical unclonable functions (PUF) provide a space-saving and therefore cost-effective possibility for authenticating a physical object using its intrinsic physical properties. For this purpose, for a predefined challenge value, the PUF determines an associated response value depending on object-specific physical properties of the object. An examiner wishing to authenticate an object may identify the object as the original object by comparing the similarity of the available response values and the response values provided by the authenticated object in the case of known challenge-response pairs.

Further uses of a PUF are known, in particular, the on-chip determination of a cryptographic key using a PUF. The cryptographic key determined is used in this case inside the chip to calculate a cryptographic operation.

The PUF raw data (e.g., response) is also post-processed in order to compensate for statistical fluctuations of the PUF response to a particular challenge (for example, by a forward error correction or a feature extraction in a manner corresponding to conventional fingerprint authentication).

Yousra M. Alkabani, Farinaz Koushanfar: Active Hardware Metering for Intellectual Property Protection and Security, 16th USENIX Security Symposium, 2007, http://www.usenix.org/event/sec07/tech/fullpapers/alkabani/alkabani.pdf discloses the practice of preventing “overbuilding” of semiconductor ICs using a PUF. For this purpose, the state machine required for the function of the IC is modified such that the machine contains a large number of states that are not required for the desired function. The starting state is determined using a PUF, that is to say the IC starts the execution in a starting state that is dependent on random, specimen-specific properties. Only the designer of the IC, who knows the design specification of the state machine, may feasibly ascertain for a particular IC a path from the random initial state to a starting state that is required for the use of the functionality, and hence program a manufactured IC.

An advantage of PUFs is that a PUF structure is altered during physical manipulation and this allows tamper protection to be achieved. Furthermore, PUFs may also be used when a module does not have memory for permanently storing a cryptographic key (this requires either specific methods of manufacture, e.g., for flash memories, or a backup battery for SRAM memory cells).

Various physical implementations of a physical unclonable function are known. Many PUFs may be implemented easily and in a space-saving manner on an IC (digital or analog). There is no need for a permanent key memory or for the implementation of cryptographic algorithms.

The fact that a PUF authentication server determines challenge-response pairs during operation and stores the challenge-response pairs for future authentication operations (e.g., checking processes) is known as PUF replenishment (see http://ip.com/IPCOM/000127000, title: CRP replenishment protocol for PUFs).

It is known practice to carry out PUF-based authentication, in which case challenge-response pairs from another, trusted entity are used for the first time to acquire reference data for further challenge-response pairs that may be used for subsequent authentication operations (see U.S. Patent Publication No. 2009/0083833, in particular sections 6 and 15).

During authentication, there may be an authenticator (also called examiner) and an authentication object (also called authenticator, test object, or supplicant). It is known that the authenticated person or object uses a PUF to be authenticated.

FIG. 1 depicts an authentication system 80 according to the prior art. The authentication checking function 85 belonging to an examiner 83 selects a challenge c in the prior art and transmits the challenge c to the test object 82. The test object 82 receives the challenge c and uses a PUF 86 of the test object 82 to determine a response value r. The response value r is made available to the examiner 83. The latter uses a list 87 of stored challenge-response pairs (e.g., CR pairs) to determine whether the response r provided by the test object 82 is valid. This may be carried out, for example, by comparing the similarity of the response value r provided by the test object 82 with a reference response value stored for the challenge value c used. Identical response values and response values with a Hamming distance of a maximum of 2 (that is to say, a maximum of 2 bits may be different), for example, may be accepted as valid. If the response r provided by the test object 82 is accepted as valid, an accept signal a is provided, that is to say the test object 82 is accepted as valid. An RFID tag, a battery or the like, for example, may be identified as valid (e.g., original product). However, the disadvantage of this system is that the examiner requires costly memory components and provides a target for reading the CR pairs, which then allow attacks on the system protected by the examiner.

### SUMMARY

The scope of the present invention is defined solely by the appended claims and is not affected to any degree by the statements within this summary. The present embodiments may obviate one or more of the drawbacks or limitations in the related art.

There is a need for authentication that is sufficiently resistant to attacks and may be used in a cost-effective and simple manner in the process. The present embodiments are based on the object of meeting this need.

A first aspect discloses a method for checking authentication of an authentication object using an authenticator. The authenticator includes a physical unclonable function (PUF) and an authentication checking function. The authenticator is provided with a challenge-response pair. The challenge-response pair includes an item of challenge information (or “challenge”) and an item of response information (or “response”). The response is made available to the authenticator by the authentication object. The challenge information is used as an input for the PUF. The PUF generates a PUF response in response to the input of the challenge information. The PUF response and the response are used for a comparison. An enable signal is provided on the basis of a result of the comparison.

According to another aspect, an authenticator for authenticating an authentication object is provided. The authenticator includes a PUF, an authentication checking function, and an acquisition device for acquiring a challenge-response pair. The challenge-response pair includes an item of challenge information and an item of response information. The acquisition device is configured to receive the response information from the authentication object. The authenticator is configured to transfer the response to the authentication checking function, to use the challenge information sent by the authentication object as an input for the PUF and to likewise transfer a PUF response generated in response thereto by the PUF to the authentication checking function. The authentication checking function is configured to use the PUF response and the response for a comparison. The comparison provides an enable signal on the basis of the result of the comparison.

According to another aspect, an authentication system includes the authenticator described above and an authentication object, the authentication object being configured to provide the authenticator with the response.

### BRIEF DESCRIPTION OF THE DRAWINGS

FIG. 1 depicts a system for authenticating an authentication object according to the prior art.

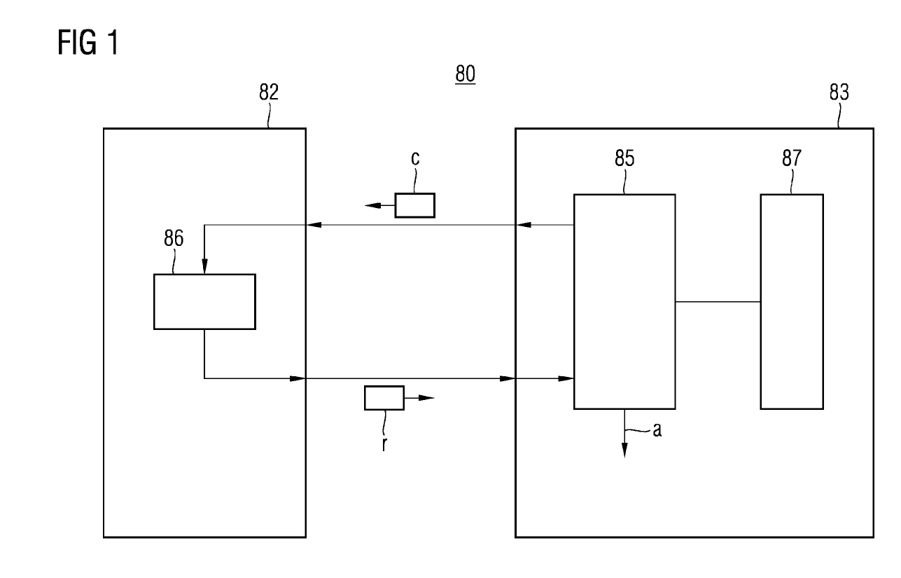

FIG. 2 depicts an embodiment of a system for authenticating an authentication object.

### DETAILED DESCRIPTION

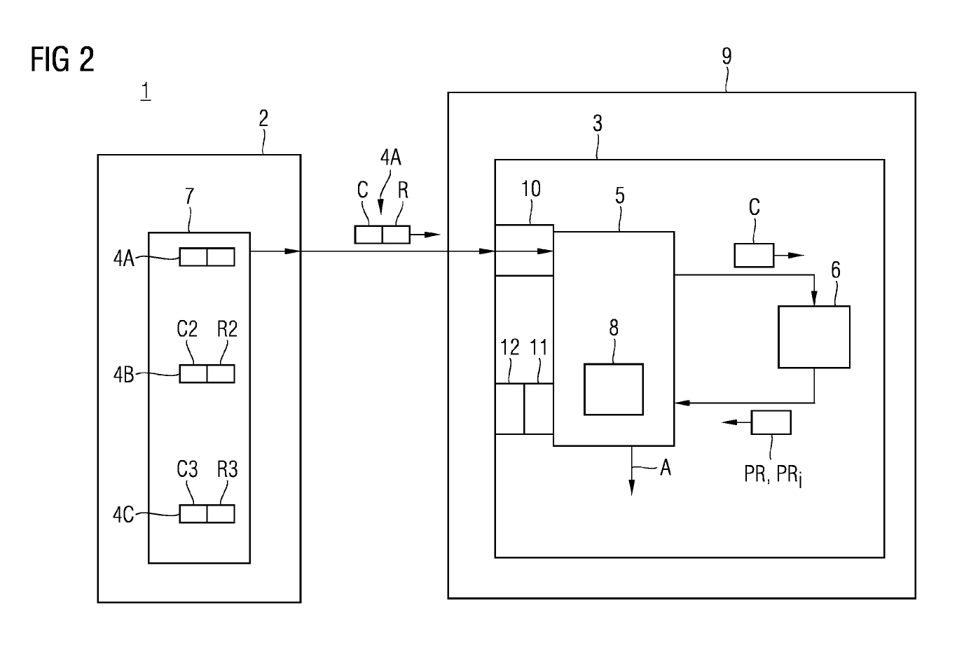

FIG. 2 depicts an authentication system 1 that includes an authentication object 2 and an electronic part 9. The electronic part 9 includes an authenticator 3, and the authentication object 2 includes a memory area 7. Challenge-response pairs 4A, 4B, 4C are stored in the memory area 7. Each of the challenge-response pairs 4A, 4B, 4C includes an item of challenge information C, C2, C3, also called challenge value C, C2, C3 or simply challenge C, C2, C3 below, and an item of response information R, R2, R3 is assigned to one of the challenges and is also called response value R, R2, R3 or response R, R2, R3 below.

The authenticator 3 includes an authentication checking function 5, a physical unclonable function (PUF) 6 and an acquisition device 10 for acquiring challenge-response pairs 4A, 4B, 4C.

In order to check the authenticity or the authorization of the authentication object 2, the authenticator is provided with a challenge-response pair 4A. In the exemplary embodiment illustrated in FIG. 2, the challenge-response pair 4A is transmitted to the authenticator 3 by the authentication object 2. The authenticator 3 uses the challenge information C as an input for the PUF 6, which generates a PUF response PR in response to the input of the challenge information C. The PUF response PR and the response R are used for a comparison, an enable signal A being provided on the basis of the result of the comparison.

According to further embodiments, it is not necessary for the authentication object 2 to store the challenge-response pairs 4A, 4B, 4C. The authentication object 2 may retrieve the challenge-response pairs 4A, 4B, 4C from a database or may calculate the challenge-response pairs 4A, 4B, 4C using a calculation model of the PUF 6. It is likewise not necessary for the authentication object to provide the PUF with the entire challenge-response pair 4A. It is sufficient if the response R is made available to the authenticator 3 by the authentication object 2. The challenge information C may also be selected by the authenticator 3 or by a third entity.

According to an embodiment, a degree of match is determined during the comparison. The degree of match is compared with a threshold value. The enable signal A may be provided if the determined degree of match reaches or exceeds the threshold value.

It is possible to carry out a check during the comparison in order to determine, for example, whether: (a) the response R sufficiently matches the PUF response PR; or (b) for repeated input of the challenge information C to the PUF 6, the PUF responses PR, generated by the PUF 6 as a result sufficiently match the response R; or (c) for inputs of different challenge information C, C2, C3 to the PUF 6, the PUF responses PR, PR2, PR3 generated by the PUF 6 as a result sufficiently match the responses R, R2, R3 belonging to the respective challenges C, C2, C3.

The authentication object 2 may be configured to provide the authenticator 3 with a plurality of responses R, R2, R3 or challenge-response pairs 4A, 4B, 4C.

According to another embodiment, the electronic part 9 is configured to be in either an open or a restricted state.

A function of the electronic part may not be used or may be used only in a restricted manner in the restricted state in this case. The enable signal A need not necessarily be used to restrict a function of the electronic part 9; the enable signal A may also be used to restrict external functions, that is to say to restrict functions of further systems or components.

According to an embodiment, the authentication object 2 additionally provides PUF correction data that are used by the authenticator 3 to verify the response R, R2, R3 provided and the PUF response PR, PR2, PR3, PR, generated using the PUF 6. For this purpose, the acquisition device 10 is also configured to receive the PUF correction data from the authentication object 2.

The authenticator 3 may determine an item of identification information relating to the authentication object 2 when acquiring the challenge-response pair 4A or the challenge-response pairs 4A, 4B, 4C and, on the basis thereof, determines a cryptographic key for transmitting responses R, R2, R3 in an encrypted manner or for transmitting challenge-response pairs 4A, 4B, 4C in an encrypted manner between the authenticator and the authentication object or between a function that may be enabled and the authentication object 2. Communication may also take place between the function that may be enabled and the authenticated object (e.g., additional variant). In this case, the authenticator 3 would determine a cryptographic key and would make the cryptographic key available to the function that may be enabled.

According to another embodiment, the authenticator 3 determines, on the basis of the challenge-response pair 4A made available to the authenticator 3 or on the basis of the challenge-response pairs 4A, 4B, 4C made available to the authenticator 3, a cryptographic key for transmitting responses R, R2, R3 in an encrypted manner or for transmitting challenge-response pairs 4A, 4B, 4C in an encrypted manner between the authenticator 3 and the authentication object 2 or between a function that may be enabled and the authentication object 2. The challenge values C, C2, C3 or the challenge-response pairs 4A, 4B, 4C are therefore used directly to determine a key. The identification information relating to the authentication object 2 may therefore also be provided by the challenge value(s) C, C2, C3 or the challenge-response pair(s) 4A, 4B, 4C (in addition to the conventional variant in which a username, a serial number, or a network address is used).

In order to determine the cryptographic key(s), the authenticator 3 includes a cryptographic device 11.

According to another embodiment, the authenticator 3 includes a provision device 12 configured to provide further challenge-response pairs for future authentication operations after accepting the authentication object 2.

According to another embodiment, the method includes providing the authentication object 2 and the authenticator 3.

According to one embodiment, response values associated with selectable challenge values may be determined using the physical unclonable function PUF. For a particular challenge value, only similar response values but not response values that are identical on a bit-by-bit basis are may be determined in a plurality of runs. A PUF may clearly be considered to be the “fingerprint” of a hardware object. A PUF has hitherto been able to be used according to the known prior art to identify the object using its “fuzzy” fingerprint. It is also known practice to internally determine a cryptographic key from PUF responses using error correction methods and stored correction data.

According to one embodiment, a physical unclonable function PUF of an object is now not used to calculate a response, which is made available to an external entity for checking, as part of object authentication, as in the prior art, but rather is used to check a received response or a challenge-response pair by the object. As a result, a PUF of an object (for example, of a semiconductor IC such as a memory module, an FPGA, or an ASIC, or of a so-called system-on-chip SoC) may not only be used to authenticate the object by an outsider, as previously. Instead, the object itself may authenticate an outsider using the PUF of the object and, on the basis thereof, may enable a particular function (for example, memory access to a particular memory area, execution/start of a control algorithm, or a functionality implemented by the IC, checking/diagnostic interface of the IC (e.g., JTAG interface)).

Valid challenge-response pairs of a chip for future authentication operations may be acquired, for example, as long as the chip is in an open mode (for example, security fuse not blown). The challenge-response pairs may be read by an authorized user and may be stored in a database, for example, or it is possible to determine, if necessary, a chip model that may be used to calculate the valid responses for any desired challenges. The chip may then be “locked”, for example, by blowing a fuse. Access to a protected functionality is then only possible after a valid response value has been provided. After access has been granted, the PUF may be used in one variant to provide further challenge-response pairs for future authentication operations.

In other words, according to one embodiment, the PUF 6 is used in a dual manner, namely by the authenticator 3. In this case, the PUF 6 therefore now does not implement an authentication function in the role of the test object, but rather authentication verification in the role of the examiner. This makes it possible to now use a PUF 6, which may be implemented in a simple and cost-effective manner, for an entirely new purpose.

According to an embodiment, the PUF 6 is now used to check a response R provided. In the example illustrated in FIG. 2, the test object 2 provides a challenge-response pair C, R. The response value R is stored in this case. In the event of successful authentication, the authentication checking function 5 provides an accept signal A. This may enable a function of the examiner 3 (for example, a diagnostic interface, configuration mode, feature enabling). In one variant, the examiner 3 may provide the test object 2 with a message relating to success or failure.

A comparator 7 of the authenticator 3 checks the response R provided by the authenticated person or object 2 and the (e.g., expected) response PR determined by the PUF 6 of the authenticator 3 for consistency (e.g., sufficient similarity). If necessary, the internal PUF 6 of the authenticator 3 may be queried repeatedly for the same challenge information C in order to obtain a plurality of PUF responses PR, for a particular item of challenge information C. This makes it possible to achieve a higher recognition rate (response information items PR, from the PUF 6 for a fixed challenge value are not identical with bit accuracy, but rather are only statistically similar).

The challenge value C may be selected by the object 2 (e.g., test object) being authenticated, by the authenticator 3 (e.g., examiner) or by a third party. It is possible to use an identical item of challenge information C, but may be plurality of changing items of challenge information C, C2, C3.

In one variant, in addition to the response R (or as part of the response), the test object 2 provides PUF correction data (helper data/fuzzy extractor parameters, for example, parameters for a forward error correction), which are used by the examiner 3 to verify the response R provided and the response value PR determined using the physical PUF 6. When initially acquiring challenge-response pairs (also called C-R pairs below), the examiner 3 additionally provides correction data in addition to the C-R pair or the response R associated with a particular item of challenge information C. In one variant, the correction data have a selectable parameter (for example, a PIN or a password). This has the advantage that authentication using a password, PIN, or the like is possible, the password or the PIN being checked using a PUF and the correction data. For this purpose, the examiner 3 therefore need not store any checking information but rather may check a provided password using a PUF and provided data. When initially acquiring C-R pairs, the examiner 3 additionally provides correction data in addition to the C-R pair or the response value R associated with a particular challenge value C, the response value R and the correction data depending on a selectable parameter (e.g., PIN, password) made available to the examiner 3. The test object 2 then stores only a C-R pair or correction data, but not the password or the PIN. In order to successfully carry out authentication, the password or the PIN is made available to the test object 2, for example, by a user using an input option, with the result that the authentication data needed for successful authentication are available to the test object 2 and may therefore be made available to the examiner 3.

The test object 2 may store C-R pairs 4A, 4B, 4C of the authenticator 3, may retrieve the C-R pairs from a database or may calculate the C-R pairs using a calculation model of the PUF 6. For this purpose, the (e.g., physical) PUF 6 is measured in an initialization phase in order to determine the model parameters. In both cases (CR pairs, model parameters), the data have been acquired and stored at an earlier time, for example, during manufacture of the authenticator. If the test object 2 retrieves a C-R pair from a database, this retrieval may be carried out via a communication connection in one variant, for example, via an IP/http connection. This may be protected using IPsec or SSL/TLS, for example. The test object 2 is authenticated with respect to the database server using a password or a cryptographic key, for example. Only if the test object 2 is authorized to enable a functionality on an examiner component is the test object 2 provided with a C-R pair for enabling the functionality by the database server.

After a blocking operation of the authenticator 3, the latter may be used in a restricted operating mode. For example, a diagnostic interface (e.g., JTAG, RS232, USB) may be blocked, and a particular functionality (for example, access to a memory area, use of a stored key) may be prevented. This functionality is enabled only after providing a C-R pair that may be successfully checked using the PUF 6. The functionality may remain enabled until a blocking command is received or a power supply is interrupted or until a reboot.

The described authentication may also be combined with further authentication methods, for example, a conventional password check or cryptographic challenge-response authentication. A different functionality may be enabled depending on the authentication variant used. In another variant, a plurality of authentication operations is successfully run through in order to enable a functionality of the examiner 3.

In one variant, the C-R pair 4A or the response value R, which is transmitted to the examiner 3, is cryptographically encrypted. In this case, the examiner 3 uses a stored cryptographic key in order to decrypt the received C-R pair 4A or the received response R. The decrypted value is internally made available to the PUF 6 for checking.

When acquiring C-R pairs 4A, 4B, 4C for subsequent use, an item of identification information relating to the test object 2 may be determined by the examiner 3 and, on the basis thereof, a cryptographic key for encrypting C-R pairs 4A, 4B, 4C or responses R, R2, R3 may be determined. As a result, a particular test object 2 is provided with C-R pairs 4A, 4B, 4C for subsequent authentication operations that are tied to the test object's identity. Another test object with a different identity may not use these C-R pairs. This prevents simple copying of C-R pairs 4A, 4B, 4C and use by another test object. In the case of subsequent authentication of the test object by the examiner, the test object's identity is first of all detected and the key is reconstructed on the basis thereof in order to use it to decrypt C-R pairs or responses received by it.

The key specific to the test object may be determined, for example, using a cryptographic key derivation function (KDF) or a cryptographic hash function. A key specific to the test object is derived from a key not tied thereto (that is to say calculated using a one-way function). The original key used in this case may be permanently predefined, may be configurable or may be determined from a PUF (e.g., identical to or different from the authentication verification PUF).

According to one embodiment, an alternative to a password check is provided. During a password check, the password or a checking parameter dependent on the password is stored. There is therefore no need for a memory and it is therefore also suitable for ICs that do not have a possibility of permanently storing data. Otherwise, a memory would have to be provided (for example, problematic in terms of manufacture) or blowable fuses (which are therefore also a memory) and an SRAM buffer battery would have to be provided (e.g., battery problematic) or an external EEPROM memory would have to be used (e.g., costs, interface to the EEPROM may be attacked).

There is also no need to provide a cryptographic algorithm (e.g., cryptographic hash function or the like) in order to carry out a cryptographic challenge-response protocol (e.g., chip area, power consumption).

Furthermore, the module does not have a password that may possibly be read (for example, not stored in the memory in plain text), where it may be read by attacks.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for checking authentication of an authentication object using an authenticator comprising a physical unclonable function (PUF) and an authentication checking function, the method comprising:
providing at least one challenge-response pair for the authenticator, the challenge-response pair comprising challenge information and a response, the response being made available to the authenticator by the authentication object;
using the challenge information as an input for the PUF, which generates a PUF response in response to the input of the challenge information;
using the PUF response and the response for a comparison, an enable signal being provided on the basis of a result of the comparison.

2. The method as claimed in claim 1, wherein a degree of match is determined during the comparison, wherein the degree of match is compared with a threshold value, and the enable signal is provided when the determined degree of match reaches or exceeds the threshold value.

3. The method as claimed in claim 1, wherein a check is carried out during the comparison in order to determine whether:
a) the response matches the PUF response; or
b) for repeated input of the challenge information to the PUF, PUF responses generated by the PUF as a result match the response; or
c) for inputs of different challenge information to the PUF, the PUF responses generated by the PUF as a result match responses belonging to respective challenges.

4. The method as claimed in claim 1, wherein the authentication object further provides the authenticator with the challenge information in addition to the response.

5. The method as claimed in claim 1, wherein the authentication object comprises a chip with a memory area in which the at least one challenge-response pair is stored.

6. The method as claimed in claim 1, wherein the authentication object provides a plurality of challenge-response pairs, stores the plurality of challenge-response pairs in the memory area, or provides the plurality of challenge-response pairs and stores the plurality of challenge-response pairs in the memory area.

7. The method as claimed in claim 1, wherein the authenticator is included in an electronic part, the electronic part being configured to be in either an open or a restricted state, and a function of the electronic part not being able to be used or being able to be used only in a restricted manner in the restricted state.

8. The method as claimed in claim 1, wherein the authentication object provides PUF correction data, the PUF correction data being used by the authenticator to verify the response provided and the PUF response generated using the PUF.

9. The method as claimed in claim 1, wherein the authentication object stores the at least one challenge-response pair, retrieves the at least one challenge-response pair from a database, or calculates the at least one challenge-response pair using a calculation model of the PUF.

10. The method as claimed in claim 1, wherein the authenticator determines an item of identification information relating to the authentication object when providing the at least one challenge-response pair and, on the basis thereof, determines a cryptographic key for transmitting responses in an encrypted manner or for transmitting the at least one challenge-response pair in an encrypted manner between the authenticator and the authentication object or between a function configured to be enabled and the authentication object.

11. The method as claimed in claim 1, wherein the authenticator determines, on the basis of the at least one challenge-response pair made available to the authenticator, a cryptographic key for transmitting responses in an encrypted manner or for transmitting the at least one challenge-response pair in an encrypted manner between the authenticator and the authentication object or between a function configured to be enabled and the authentication object.

12. The method as claimed in claim 1, wherein the authenticator provides further challenge-response pairs for future authentication operations after accepting the authentication object.

13. An authenticator for authenticating an authentication object, the authenticator comprising:
a physical unclonable function (PUF);
an authentication checking function; and
an acquisition device for acquiring at least one challenge-response pair, the challenge-response pair comprising challenge information and a response, the acquisition device configured to receive the response from the authentication object,
wherein the authenticator is configured to transfer the response to the authentication checking function, use the challenge information sent by the authentication object as an input for the PUF, and transfer a PUF response generated in response thereto by the PUF to the authentication checking function, and
wherein the authentication checking function is configured to use the PUF response and the response for a comparison, an enable signal being provided on the basis of a result of the comparison.

14. The authenticator as claimed in claim 13, wherein the authentication checking function is configured to determine a degree of match during the comparison, wherein the degree of match is compared with a threshold value, and the authenticator is configured to provide the enable signal when the determined degree of match reaches or exceeds the threshold value.

15. The authenticator as claimed in claim 13, wherein the authentication checking function is configured to carry out a check during the comparison in order to determine whether:
a) the response matches the PUF response; or
b) for repeated input of the challenge information to the PUF, PUF responses generated by the PUF as a result match the response; or
c) for inputs of changing challenge information to the PUF, the PUF responses generated by the PUF as a result match responses.

16. The authenticator as claimed in claim 13, wherein the acquisition device is further configured to receive the challenge information from the authentication object.

17. The authenticator as claimed in claim 13, wherein
the acquisition device is further configured to receive PUF correction data from the authentication object and use the PUF correction data to verify the response provided and the PUF response determined using the PUF.

18. The authenticator as claimed in claim 13, wherein the authenticator is configured to determine identification information relating to the authentication object on the basis of the acquisition of the at least one challenge-response pair acquired by the acquisition device and, on the basis thereof, to determine a cryptographic key for transmitting responses in an encrypted manner or for transmitting the at least one challenge-response pair in an encrypted manner between the authenticator and the authentication object or between a function configured to be enabled and the authentication object.

19. The authenticator as claimed in claim 13, further comprising a cryptographic device configured to determine, on the basis of the acquired at least one challenge-response pair, a cryptographic key for transmitting responses in an encrypted manner or for transmitting the at least one challenge-response pair in an encrypted manner between the authenticator and the authentication object or between a function configured to be enabled and the authentication object.

20. The authenticator as claimed in claim 13, further comprising a provision device configured to provide further challenge-response pairs for future authentication operations after accepting the authentication object.

21. The authenticator as claimed in claim 13, wherein the authenticator is included in an electronic part configured to be either in an open state or in a restricted state, and a function of the electronic part not being able to be used or being able to be used only in a restricted manner in the restricted state.

22. An authentication system comprising:
an authenticator; and
an authentication object configured to provide the authenticator with a response,
wherein the authenticator comprises:
a physical unclonable function (PUF);
an authentication checking function; and
an acquisition device for acquiring a challenge-response pair, the challenge-response pair comprising challenge information and a response, the acquisition device configured to receive the response from the authentication object,
wherein the authenticator is configured to transfer the response to the authentication checking function, use the challenge information sent by the authentication object as an input for the PUF, and transfer a PUF response generated in response thereto by the PUF to the authentication checking function, and
wherein the authentication checking function is configured to use the PUF response and the response for a comparison, an enable signal being provided on the basis of a result of the comparison.

23. The authentication system as claimed in claim 22, the authentication object comprising a chip with a memory area in which the challenge-response pair is stored.

24. The authentication system as claimed in claim 22, wherein the authentication object is configured to provide a plurality of challenge-response pairs and to store the plurality of challenge-response pairs in the memory area.

25. The authentication system as claimed in claim 22, wherein the authentication object stores the challenge-response pair, retrieves the challenge-response pair from a database, or calculates the challenge-response pair using a calculation model of the PUF.
